(19) United States
(12) Patent Application Publication
(10) Pub. No.: US 2026/0252342 A1
(43) Pub. Date: Aug. 27, 2026

(54) COMPONENT CONFIGURATION METHOD, APPARATUS, DEVICE, AND MEDIUM

(71) Applicants: Chengdu BOE Smart Technology Co., Ltd., Chengdu, Sichuan (CN); BOE Technology Group Co., Ltd., Beijing (CN); Beijing BOE Technology Development Co., Ltd., Beijing (CN)

(72) Inventor: Xin LI, Beijing (CN)

(21) Appl. No.: 18/992,959

(22) PCT Filed: Apr. 28, 2023
(86) PCT No.: PCT/CN2023/091641

§ 371 Date: Jan. 9, 2025

(51) Int. Cl. G06F 8/71; G06F 9/445

(52) U.S. Cl. CPC G06F 8/71; G06F 9/44505

(57) ABSTRACT

The present disclosure relates to a component configuration method, an apparatus, a device, and a medium. According to embodiments of the present disclosure, based on the component configuration information that may indicate the correspondences between the different project components and the configuration parameters, the configuration parameters corresponding to the target project component to be configured are directly obtained, then based on the target project component and the configuration parameters, a component configuration interface is displayed, such that users may set the parameter values of the configuration parameters corresponding to the target project component through the component configuration interface, and then generate configuration files based on the target project component and the parameter values set through the component configuration interface.

### TECHNICAL FIELD

The present disclosure relates to the field of display computer technologies, and in particular, to a component configuration method, an apparatus, a device, and a medium.

### BACKGROUND

Spring Boot, as an open source framework that may simplify the construction and development process of Spring applications, may omit a large number of Extensible Markup Language (XML) files and simplify complex dependency management in Spring applications. Spring Initializr, as a tool officially provided by Spring, may be used to initialize Spring Boot projects and automatically generate project structures for Spring Boot projects.

The Spring Boot framework integrates multiple types of components such as Web components, template engine components, security components, database components, etc., and each component needs to set component coordinates and configuration items. However, Spring Initializr tool can only introduce component coordinates in a project file, but cannot automatically generate component configuration items, so the setting of component configuration items still needs to rely on the manual operation of technicians.

In the above implementation process, when setting configuration items for components, technicians need to search for the configuration items that need to be set among numerous component configuration items, which thus makes the component configuration process less efficient.

### SUMMARY

The present disclosure provides a component configuration method, an apparatus, a device, and a medium, to resolve the deficiencies in the related technologies.

According to a first aspect of embodiments of the present disclosure, a component configuration method is provided, including:
obtaining, based on preset component configuration information, configuration parameters corresponding to a target project component to be configured, where the preset component configuration information indicates the configuration parameters corresponding to each project component;
displaying, based on the target project component and the configuration parameters corresponding to the target project component, a component configuration interface, where the component configuration interface is configured to set parameter values of the configuration parameters corresponding to the target project component; and
generating, based on the target project component and the parameter values set through the component configuration interface, a configuration file.

According to a second aspect of embodiments of the present disclosure, a component configuration apparatus is provided, including:
an obtaining module, configured to obtain, based on preset component configuration information, configuration parameters corresponding to a target project component to be configured, where the preset component configuration information indicates configuration parameters corresponding to each project component;
a displaying module, configured to display, based on the target project component and the configuration parameters corresponding to the target project component, a component configuration interface, where the component configuration interface is configured to set parameter values of the configuration parameters corresponding to the target project component; and
a generating module, configured to generate, based on the target project component and the parameter values set through the component configuration interface, a configuration file.

According to a third aspect of embodiments of the present disclosure, an electronic device is provided, including a memory, a processor, and a computer program stored in the memory and executable on the processor, wherein the processor executes the computer program to implement operations executed by the component configuration method provided according to the above-mentioned first aspect.

According to a fourth aspect of the embodiments of the present disclosure, a computer-readable storage medium storing a program is provided, the program when executed by a processor implementing operations executed by the component configuration method provided according to the above-mentioned first aspect.

According to the above embodiments, it can be seen that, the present disclosure directly obtains, based on the component configuration information that may indicate the correspondence between the different project components and the configuration parameters, the configuration parameters corresponding to the target project component to be configured, and then displays, based on the target project component and the configuration parameters corresponding to the target project component, a component configuration interface, such that users may set the parameter values of the configuration parameters corresponding to the target project component through the component configuration interface, and then generate configuration files based on the target project component and the parameter values set through the component configuration interface. Through a solution provided in the present disclosure, without the need for users to manually search, the parameter values of the configuration parameters that need to be configured for each component may be set, which improves the efficiency of component configuration.

It should be understood that the above general descriptions and the following detailed descriptions are merely for exemplary and explanatory purposes, and cannot limit the present disclosure.

### BRIEF DESCRIPTION OF DRAWINGS

The accompanying drawings, which are incorporated in and constitute a part of the present description, illustrate embodiments consistent with the present disclosure and serve to explain the principles of the present disclosure together with the description.

FIG. 1 is a flowchart of a component configuration method according to an embodiment of the present disclosure.

FIG. 2 is an interface overview of a component selection interface according to an embodiment of the present disclosure.

FIG. 3 is an interface overview of a component configuration interface according to an embodiment of the present disclosure.

FIG. 4 is an interface overview of a configuration file generation interface according to an embodiment of the present disclosure.

FIG. 5 is a flowchart of a component configuration method according to an embodiment of the present disclosure.

FIG. 6 is a system architecture diagram of a component configuration system according to an embodiment of the present disclosure.

FIG. 7 is a box diagram of a component configuration apparatus according to an embodiment of the present disclosure.

FIG. 8 is a structural diagram of an electronic device according to an embodiment of the present disclosure.

### DETAILED DESCRIPTION

Embodiments will be described in detail here, examples of which are illustrated in the accompanying drawings. When the following description relates to the accompanying drawings, unless specified otherwise, the same numerals in different drawings represent the same or similar elements. The implementations described in the following embodiments do not represent all implementations consistent with this application. Rather, they are merely examples of apparatuses and methods consistent with some aspects of the present disclosure as detailed in the appended claims.

The present disclosure provides a component configuration method, which is used during the development process of software applications to help a relevant technician quickly find the configuration items of each component in the software application, which improves the efficiency of component configuration.

The above software applications may be various types of software applications, e.g., Spring applications, or other types of applications, the specific types of software applications are not limited in the present disclosure.

For example, if a software application is a Spring application, a Spring application involve multiple types of components, such as Web components, template engine components, security components, and database components. For each type of components, there are a very large number of configuration items. Usually, relevant technicians can only remember a few common configurations, and detailed configuration settings need to be searched by relevant technicians from the official documentation of the component, which is time-consuming, labor-intensive, and low-efficiency. In view of this, the component configuration method provided in the present disclosure may be used to help a relevant technician to quickly find the configuration items of each component in the Spring application, so as to improve the efficiency of component configuration.

The above is only an exemplary explanation of the application scenarios of the present disclosure and does not constitute a limitation on the application scenarios of the present disclosure. In more possible implementations, the component configuration method provided by the present disclosure may also be applied to other scenarios involving a component configuration process. The specific application scenarios of the component configuration method are not limited in the present disclosure.

The above component configuration method may be performed by an electronic device, which may be a terminal device, such as a desktop computer, a portable computer, a notebook computer, a smart phone, a tablet computer, a smart watch, etc. In some embodiments, the electronic device may also be other types of devices. The device types of the electronic devices are not limited in the present disclosure.

The above component configuration method may be directly deployed to the public network environment through a cloud server, to obtain a network address that may provide the usage function of the above-mentioned component configuration method, then relevant technicians may use the component configuration method through the network address on an online platform (such as a browser platform), to configure the components of the project that they are developing.

Alternatively, the above component configuration method may be encapsulated into a software development kit (SDK). Relevant technicians, by downloading and installing the SDK, may integrate the above component configuration method into a development software they use, such that the relevant technicians may, when developing software applications through the development software, use the above component configuration method to configure the components of the project they are developing, and the installation process of the SDK is simple, which thus may reduce the operation difficulty of the relevant technicians.

When the above component configuration method is encapsulated into an SDK, the function code used to implement the component configuration method may be encapsulated into a Maven dependency to implement SDK encapsulation. In some embodiments, the encapsulated SDK may provide an access interface (e.g., a web access interface), such that the development software integrated with the SDK may perform data interaction with the SDK through the access interface, so as to realize a series of operations such as scanning configuration items and writing project files, which achieves the purpose of quickly configuring project components.

Compared with traditional Integrated Development Environment (IDE) plug-ins, the above two deployment methods may eliminate the tedious steps of installing plug-ins, reduce operation costs, and improve component deployment efficiency.

After the description of the application scenarios and implementation environments of the present disclosure, the component configuration method provided in the present disclosure is described in detail below.

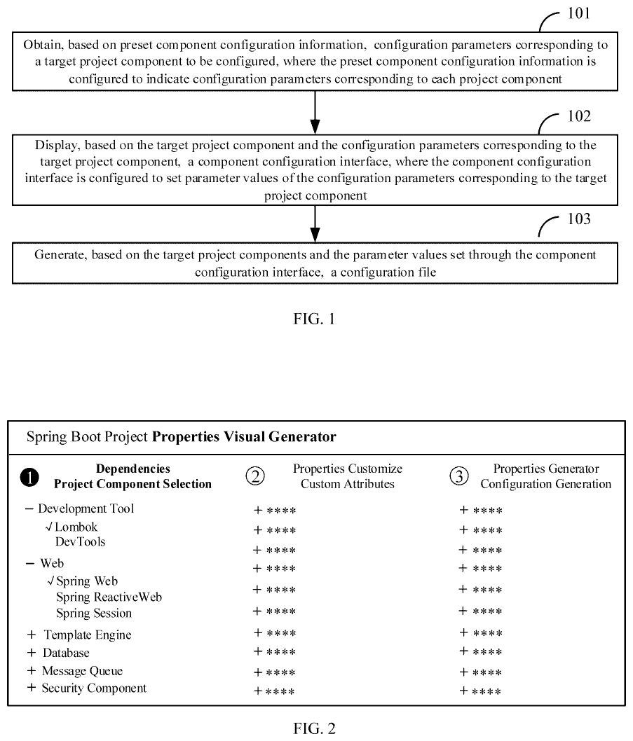

Referring to FIG. 1, FIG. 1 is a flowchart of a component configuration method according to an embodiment of the present disclosure. As illustrated in FIG. 1, the method includes step 101 to step 103.

At step 101, based on preset component configuration information, configuration parameters corresponding to a target project component to be configured are obtained, where the preset component configuration information indicates configuration parameters corresponding to each project component.

It should be noted that, due to the different component properties and functions of different components, each component has its own corresponding series of configuration parameters. In addition, for different versions of the same component, the corresponding configuration parameters may also be different, therefore, the configuration parameters corresponding to each project component (i.e., component configuration information) may be maintained, such that when there is a component configuration requirement, automatic retrieval may be performed in the maintained component configuration information to quickly find the corresponding configuration parameters.

At step 102, a component configuration interface is displayed based on the target project component and the configuration parameters corresponding to the target project component, where the component configuration interface is configured to set parameter values of the configuration parameters corresponding to the target project component.

After retrieving the configuration parameters corresponding to the target project component, based on the target project component and the configuration parameters corresponding to the target project component, a component configuration interface is provided, such that the user may configure parameter values for the configuration parameters directly through the component configuration interface, so as to improve component configuration efficiency.

At step 103, based on the target project component and the parameter values set through the component configuration interface, a configuration file is generated.

The present disclosure directly obtains, based on the component configuration information that may indicate the correspondence between the different project components and the configuration parameters, the configuration parameters corresponding to the target project component to be configured, and then displays, based on the target project component and the configuration parameters corresponding to the target project component, a component configuration interface, such that users may set the parameter values of the configuration parameters corresponding to the target project component through the component configuration interface, and then generate configuration files based on the target project component and the parameter values set through the component configuration interface. Through a solution provided in the present disclosure, without the need for users to manually search, the parameter values of the configuration parameters that need to be configured for each component may be set, which improves the efficiency of component configuration.

After the description of the basic implementation process of the component configuration method provided in the present disclosure, each optional embodiment of the present disclosure is described below.

It should be noted that, the project components that need to be configured are different in different projects. Therefore, before obtaining the configuration parameters corresponding to the target project component to be configured through step 101, the following step 100 may also be included.

At step 100, the target project component to be configured is obtained.

In some embodiments, step 100 may be implemented in the following manner.

In a possible implementation, a component selection interface is displayed, at least one selectable project component is displayed in the component selection interface, and based on a component selection operation in the component selection interface, a selected selectable project component is obtained as the target project component.

By providing a component selection interface and providing a display function of one or more selectable project components through the component selection interface, users may select from the selectable project components displayed on the component selection interface according to actual project requirements to implement the determination of target project component.

In some embodiments, different types of project components may be classified and displayed through the component selection interface. For example, multiple component types may be displayed in the component selection interface, and the user may trigger any component type to view the selectable project components included under this component type. The electronic device may respond to the user's operation and display, under the triggered component type, its corresponding selectable project components, so as for the user to choose.

Taking the selection of target project component for the development process of Spring applications as an example, referring to FIG. 2, which is an interface overview of a component selection interface according to an embodiment of the present disclosure, in the component selection interface illustrated in FIG. 2, multiple component types, such as the development tool component, the Web component, the template engine component, the database component, the message queue component, and the security component, etc., are displayed. Users may, according to your actual project configuration requirements, choose from the component types displayed in the component selection interface as illustrated in FIG. 2. If a user triggers the development tool component, the two selectable project components Lombok and DevTools may be displayed in the component selection interface illustrated in FIG. 2, so as for the user to choose. As illustrated in FIG. 2, the user selects the selectable project component Lombok, a “V” is displayed in front of the selectable project component Lombok to indicate that the component is checked; if the user triggers the Web component, the three selectable project components, Spring Web, Spring Reactive Web, and Spring Session, may be displayed in the component selection interface illustrated in FIG. 2, so as for the user to choose. As illustrated in FIG. 2, the user selects the selectable project component Spring Web, and a “V” is displayed in front of the selectable project component Spring Web to indicate that the component is checked.

Lombok is a Java development plug-in that may be automatically inserted into editors and build tools, allowing Java developers to eliminate lengthy and cumbersome code in business projects through some annotations defined by Lombok. By adding an annotation defined by Lombok, the developers may define a class in the code with fully functional builder, automatic logging of variables, etc.

DevTools is a set of Web development tools that appear alongside web pages displayed in the browser. DevTools may provide powerful functions for inspecting and debugging web pages and Web applications, and even edit source files and create website projects in the DevTools environment. By using DevTools, real-time tools with a visual interface may be used to inspect, adjust and change the styles of elements in web pages; simulate how a website behaves on different devices and simulate mobile environments with different network conditions; use breakpoint debugging and the real-time console to debug JavaScript; find problems of auxiliary functions, performance, compatibility, and security in a product; use DevTools to fix auxiliary functional problems, and so on.

Spring Web is a Web framework based on view-model-controller (MVC), which is configured to receive external requests, parse parameters and pass the parameters to the service layer to facilitate the transmission of front-end and back-end data. Spring Web, as a module of the Spring framework, may be seamlessly integrated with the Spring framework.

Spring Reactive Web is a framework that contains a complete set of server-side technical, and Spring Reactive Web framework may include Web containers and Web application frameworks.

Spring Session is a sub-project in the Spring family that provides a set of application programming interfaces (API) for managing users' session control information to provide a session sharing solution. Spring Session may be easily, quickly and seamlessly integrated into the Spring framework.

In addition, if a user triggers the template engine component in the component selection interface illustrated in FIG. 2, the selectable project components such as Velocity, FreeMarker, Thymeleaf, etc., may be displayed in the component selection interface illustrated in FIG. 2, so as for the user to choose; if the user triggers the database component in the component selection interface illustrated in FIG. 2, the selectable project components such as Redis, Postgre SQL, Sybase, FoxPro, etc., may be displayed in the component selection interface illustrated in FIG. 2, so as for the user to choose; if the user triggers the message queue component in the component selection interface illustrated in FIG. 2, the selectable project components such as JMS, Kafka, RocketMQ, AMQP, etc., may be displayed in the component selection interface illustrated in FIG. 2, so as for the user to choose; if the user triggers the security component in the component selection interface illustrated in FIG. 2, the selectable project components such as SourceCheck, Quartz, AppDetectivePro, etc., may be displayed in the component selection interface illustrated in FIG. 2, so as for the user to choose.

Velocity is a template engine based on JAVA language. It allows users to reference objects defined by JAVA code simply by using a template language.

FreeMarker is a universal tool based on templates and data that may be used to generate text such as output web pages, emails, configuration files, source code, etc.

Thymeleaf is a template engine for rendering contents such as Extensible Markup Language (XML), Xtensible HyperText Markup Language (XHTML), HyperText Markup Language 5 (HTML5), etc. Thymeleaf may be opened directly from a browser to see the static effect of a page, or it can be accessed through a Web application to see the dynamic effect of a page.

Redis (Remote Dictionary Server) is a database, which is a database that is open source, written in ANSI C language, support network, and may be memory-based or persistent log-type, key-value, and it provides API interfaces in multiple programming languages.

PostgreSQL is an object relational database management system (ORDBMS) with very complete features for free softwares. PostgreSQL supports most Structured Query Language (SQL) standards and provides many other modern features, such as complex queries, foreign keys, triggers, views, transaction integrity, multi-version concurrency control, etc. Similarly, PostgreSQL may also be extended in many ways, such as by adding new data types, functions, operators, aggregate functions, index methods, procedural languages, etc. In addition, because of the flexible license, anyone may use, modify, and distribute PostgreSQL for any purpose for free.

Sybase is a relational database system, which may provide a set of application programming interfaces and may be integrated with non-Sybase data sources and servers, allowing data to be copied between multiple databases and suitable for creating multi-tier applications. The system has complete triggers, stored procedures, rules, and integrity definitions, supports optimized queries, and has good data security.

Java Message Service (JMS) is an application programming interface (API) for Message Oriented Middleware (MOM) in the Java platform, which is used to, between two applications or in a distributed system, send messages for asynchronous communication. JMS is a platform-independent API, and most MOM providers provide support for JMS.

Kafka is a distributed, partition-supported, multi-copy distributed messaging system coordinated by the distributed application coordination service (Zookeeper). Kafka may process large amount of data in real time to meet various demand scenarios.

RocketMQ is a distributed messaging middleware with low latency, high concurrency, high availability, and high reliability. RocketMQ may not only provide asynchronous decoupling and peak-shaving and valley-filling capabilities for distributed application systems, but also has the characteristics of massive message accumulation, high throughput, and reliable retry required for internet applications.

AMQP, i.e., Advanced Message Queuing Protocol, is an application layer standard advanced message queuing protocol that provides unified messaging services. It is an open standard for application layer protocols and is designed for message-oriented middlewares. Client terminals and message middlewares based on this protocol may deliver messages without being restricted by client terminal/middleware, different products, different development languages, etc.

SourceCheck, also known as the open source component security and compliance management platform (referred to as SourceCheck), is a software composition analysis (SCA) product provided by SECZONE GROUP. It is used for third-party component security management and control, including enterprise component usage management, component usage compliance audit, new vulnerability awareness and early warning, open source code audit, etc., and supports detecting source code and release package.

Quartz is a feature-rich task calling system that may create dozens, hundreds, or even thousands of simple or complex tasks.

AppDetectivePro is a network-based vulnerability assessment tool that scans database applications, which may find, review, report and patch security vulnerabilities and misconfigurations of programs, so as to protect organizations from internal and external database threats.

It should be noted that, FIG. 2 is only an exemplary form of the component selection interface and does not constitute a limitation on the specific display form of the component selection interface. The specific display form of the component selection interface is not limited in the present disclosure.

In addition, it should be noted that, during the page development process, multiple types of components may be involved. In the component selection interface illustrated in FIG. 2, only six component types, development tool components, Web components, template engine components, database components, message queue components, and security components, are taken as examples for explanation. More component types are replaced by “****”. The specific component types are not limited in the present disclosure.

In another possible implementation, file and/or code scanning is performed based on the project to be configured, so as to obtain target project component.

In some embodiments, when file scanning is performed based on the project to be configured, it may be implemented through package scanning; when code scanning is performed based on the project to be configured, it may be implemented through Java Virtual Machine (JVM) class loading.

When target project component is obtained through file and/or code scanning, the project to be configured needs to be imported in advance, such that the project to be configured may be scanned.

It should be noted that, whether through file scanning or code scanning, all project components included in the project to be configured may be obtained, and the scanned project component may be used as the target project component. In addition, through file scanning and code scanning, the component version of each project component may also be obtained, such that the configuration parameters may subsequently be set based on the component version of the target project component.

In some embodiments, the obtained multiple target project component and the component version of each target project component may be recorded in the form of a table, or other methods may be used, which is not limited in the present disclosure.

In addition, it should be noted that, when the component configuration method provided by the present disclosure is used by integrating an SDK, the SDK encapsulated based on the component configuration method provided by the present disclosure has been embedded in the development software, and the project to be configured is directly created and edited in the development software. Therefore, when the component configuration method provided by the present disclosure is used by integrating an SDK, there is no need to import the project to be configured, but the project to be configured may be directly scanned through the SDK integrated in the development software, so as to automatically obtain the target project component.

By using file and/or code scanning to obtain target project component, users may eliminate the need to manually select project components, which may simplify the operation process and improve component configuration efficiency.

After the target project component is obtained through the above process, step 101 may be used to, based on preset component configuration information, obtain configuration parameters corresponding to the target project component to be configured.

In the preset component configuration information, different types of project components correspond to different configuration parameters, and project components of the same type and different versions may also correspond to different configuration parameters. Therefore, for step 101, when based on preset component configuration information, obtaining configuration parameters corresponding to the target project component to be configured, it may be implemented in the following manner.

Based on a component type and a component version of the target project component, configuration parameters matching the component type and component version of the target project component are obtained from the preset component configuration information.

The preset component configuration information may be implemented as a component configuration information repository. The component configuration information stored in the component configuration information repository may be updated following the iterative updates of component types and component versions, that is, whenever the type and/or version of a component is updated, the updated component configuration information will be automatically added to the component configuration information repository, so as to implement incremental updates to the component configuration information and form a complete and well developed component configuration information repository, such that based on the preset component configuration information, users may be provided with the auxiliary functions for the process of component configuration item recommendation, selection, and setting.

It should be noted that, the component configuration information repository may store the correspondences between project components of different types and/or different versions and configuration parameters, such that based on the correspondences stored in the component configuration information repository, the configuration parameters corresponding to the target project component may be obtained.

In some embodiments, the configuration parameters corresponding to different project components may be stored in the form of a table in the component configuration information repository. It should be noted that, different project components may have different component types, or may have the same component type but different component versions. In other words, only project components with the same component type and the same component version are considered as the same project component.

In a possible implementation, the component configuration information repository may be stored in the cloud, such that multiple computing devices may perform a query in the component configuration information repository in the cloud, so as to obtain the configuration parameters corresponding to each target project component. In some embodiments, the cloud may provide a query interface, such that the computing device may, through the query interface, query the configuration parameters corresponding to the target project component from the component configuration information repository in the cloud.

In some embodiments, the component configuration information repository may also provide configuration prompts for various pieces of component configuration information, for example, operation prompts indicating which pieces of component configuration item information are required, which pieces of component configuration information are optional, and what is the commonly used parameter value of a certain piece of component configuration information, what is the forbidden parameter value of a certain piece of component configuration information, and suchlike, so as to explain the component configuration information from multiple dimensions and help users set configuration parameters more conveniently, efficiently, and accurately.

After the configuration parameters corresponding to the target project component are obtained through the above process, step 102 may be used to display, based on the target project component and the configuration parameters corresponding to the target project component, a component configuration interface.

In some embodiments, step 102 may, when based on the target project component and the configuration parameters corresponding to the target project component, displaying a component configuration interface, be implemented through the following steps.

At step 1021, the component configuration interface is displayed, and the target project component is displayed in the component configuration interface.

Through the provided component configuration interface and the obtained target project component displayed in the component configuration interface, users may trigger a target project component displayed in the component configuration interface, so as to trigger a display of configuration parameters corresponding to the target project component, such that the user may set the configuration parameters corresponding to the target project component.

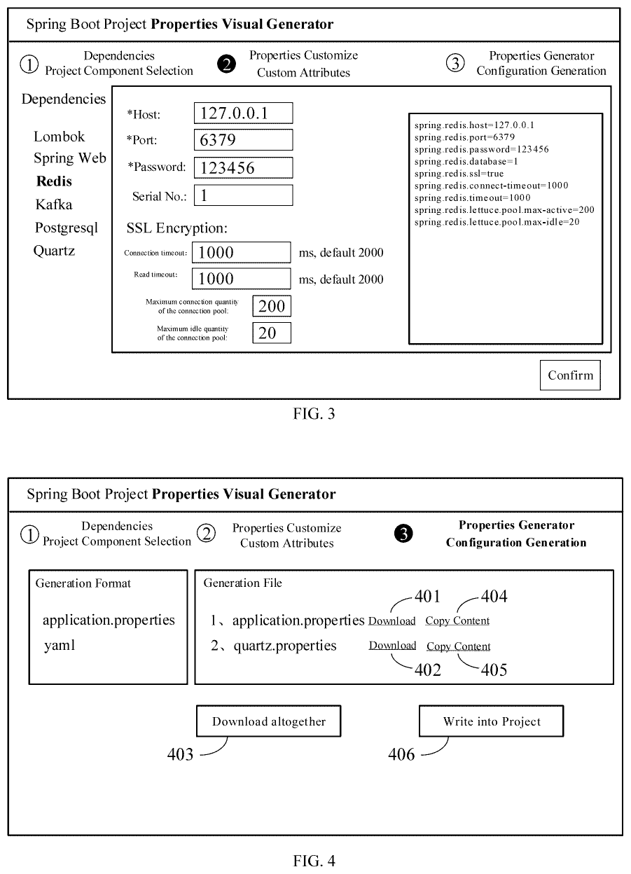

Still based on the component selection interface illustrated in FIG. 2, if a user selects, in the component selection interface illustrated in FIG. 2, Lombok as the development tool component, Spring Web as the Web component, Redis and Postgresql as the database component, Kafka as the message queue component, and Quartz as the security component, then Lombok, Spring Web, Redis, Kafka, Postgresql, and Quartz will be determined as the target project component for parameter configuration, therefore based on these six target project components, the component configuration interface illustrated in FIG. 3 may be displayed. As shown in FIG. 3, which is an interface overview of a component configuration interface according to an embodiment of the present disclosure. In the left part of the component configuration interface illustrated in FIG. 3, the six target project components: Lombok, Spring Web, Redis, Kafka, Postgresql, and Quartz are displayed. Users may, by triggering different target project components, enable the display of configuration parameters corresponding to the triggered target project component.

It should be noted that the presentation manner of the target project components illustrated in FIG. 3 is only an exemplary manner. In more possible implementations, the target project components may be presented in the component configuration interface in other manners. For example, component types of the selected target project component may be presented first, and after a component type is triggered, the target project component corresponding to the triggered component type may be expanded and presented. In this manner, the target project components may be classified and displayed. Project components of the same type will be displayed under the same component type to help users quickly focus on the parameter configuration of a certain type of target project component and improve parameter configuration efficiency.

At step 1022, in response to a triggering operation on the target project component, configuration parameters corresponding to a triggered target project component are displayed in the component configuration interface.

Still taking the component configuration interface illustrated in FIG. 3 as an example, if a user triggers the Redis target project component in the component configuration interface illustrated in FIG. 3, the configuration parameters corresponding to the Redis target project component may be displayed, as illustrated in FIG. 3, the configuration parameters that need to be configured for the Redis target project component include host, port, password, serial number, Secure Socket Layer (SSL) encryption information (including the connection timeout duration, the read timeout duration, the maximum connection quantity of the connection pool, and the maximum idle quantity of the connection pool).

In some embodiments, when configuration parameters corresponding to the target configuration component are displayed, prompt information may also be displayed based on the configuration prompts in the preset component configuration information, the prompt information prompts the required configuration parameters among the configuration parameters displayed in the component configuration interface, and/or, the prompt information prompts the forbidden parameter values of the configuration parameters displayed in the component configuration interface.

Still taking the component configuration interface illustrated in FIG. 3 as an example, the prompt information may be implemented as indicating the required configuration parameters among the configuration parameters displayed in the component configuration interface through “*” marks, that is, the configuration parameters marked with “*” marks in FIG. 3 are the required configuration parameters.

By displaying prompt information in the component configuration interface, users may perform parameter configuration according to the prompt information, improving configuration efficiency, ensuring the accuracy of parameter configuration, and improving user experience. According to the prompt information displayed in the component configuration interface, users may quickly know which configuration parameters are required configuration parameters and which are optional configuration parameters, where a required configuration parameter must be set with a parameter value, while the parameter value of the optional configuration parameter may or may not be set, such that users may configure the parameter values for different configuration parameters according to the parameter configuration requirements of those parameters, thereby improving the parameter configuration efficiency.

In some embodiments, the component configuration interface is provided with an input control, so as to obtain a parameter value set by the user for the configuration parameter corresponding to the target project component through the input control. For example, in the component configuration interface, an input control may be set for each displayed configuration parameter, such that users may enter the parameter values they set through the input control.

The above is only an exemplary manner of providing an input control. In more possible manners, input controls may also be provided in other forms. For example, an input control may be provided in a parameter configuration interface, and the parameter values of configuration parameters corresponding to each target project component may be obtained through the input control. The specific setting manners of the input component are not limited in the present disclosure.

In a possible implementation, in response to an input operation of the user in the input control, the parameter values input through the input control in the component configuration interface may be obtained.

The above is explained by examples that users directly set parameter values of configuration parameters according to the actual technical requirements. In more possible implementations, default parameter values may also be set for the configuration parameters corresponding to each project component, such that users may perform parameter setting based on the default parameter values for each configuration parameter.

In a possible implementation, in response to a triggering operation on the target project component, configuration parameters corresponding to a triggered target project component may be displayed in the component configuration interface, and the default parameter values may be displayed in the input controls corresponding to the configuration parameters.

Further, users may adjust the default parameter values that do not meet the project requirements according to actual project requirements.

In a possible implementation, in response to a modification operation on the default parameter value in the input control, the modified parameter value may be obtained as the parameter value of the configuration parameter.

In addition, the component configuration interface may further provide a code presentation function, such that users may in real time view the code generated based on the configuration parameter values set by themselves. In addition, modifications to the configuration parameter values by the users may also be synchronized in real time to the presented code. Still taking the component configuration interface illustrated in FIG. 3 as an example, as illustrated in FIG. 3, the display box on the right side of FIG. 3 is the component configured to provide the code presentation function, in which the code generated based on the configuration parameter values set in the component configuration interface illustrated in FIG. 3 may be presented.

Through the above embodiment, the parameter values of configuration parameters corresponding to the target project component may be obtained, such that through step 103, based on the target project component and the parameter values set through the component configuration interface, a configuration file may be generated.

In a possible implementation, step 103 may, when based on the target project component and the parameter values set through the component configuration interface, generating a configuration file, include the following steps.

At step 1031, in response to a confirmation operation in the component configuration interface, a configuration file generation interface is displayed, the configuration file generation interface includes at least one selectable file format.

In some embodiments, a confirmation control may be provided in the component configuration interface. After the user configures the parameter values of each configuration parameter of the target project component through the component configuration interface, the user may trigger the confirmation control in the component configuration interface, so as to trigger a confirmation operation in the component configuration interface.

Still taking the component configuration interface illustrated in FIG. 3 as an example, in the component configuration interface illustrated in FIG. 3, the “Confirm” button is the confirmation control, and users may trigger the “Confirm” button in the component configuration interface illustrated in FIG. 3 to trigger a confirmation operation in the component configuration interface illustrated in FIG. 3, so as to submit the configuration parameter values set by themselves in the component configuration interface illustrated in FIG. 3.

After a user trigger a confirmation operation in the component configuration interface, the electronic device may display the configuration file generation interface and provide at least one optional selectable file format in the configuration file generation interface. The user may, according to actual project requirements, select the format of the configuration file to be generated from the at least one selectable file format.

Referring to FIG. 4, which is an interface overview of a configuration file generation interface according to an embodiment of the present disclosure, in the configuration file generation interface illustrated in FIG. 4, application properties and yaml displayed in the generation format region, are the two selectable file formats selected by the user.

At step 1032, in response to a file generation operation in the configuration file generation interface, a configuration file matching the selected selectable file format is generated.

In some embodiments, a generation control may be provided in the configuration file generation interface. A user may, by triggering the generation control, trigger the file generation operation in the configuration file generation interface, and the electronic device may, in response to the file generation operation by the user in the configuration file generation interface, generate the configuration files that matches the selected selectable file formats.

It should be noted that, each selectable file format may have a file template corresponding to itself. When a configuration file that matches the selected selectable file format is generated, the target project component, configuration parameters and configuration parameter values corresponding to the target project component, which are obtained through steps 101 to 102, may be inserted into the preset position in the file template, so as to implement the generation of a configuration file that matches the selected selectable file format.

Still taking the configuration file generation interface illustrated in FIG. 4 as an example, the selectable file formats selected by the user include application.properties and yaml. Therefore, through the above step 1032, an application.properties file matching the selectable file format application.properties and a quartz.properties file matching the selectable file format yaml may be generated, and the two generated files are displayed in the generation file region of the configuration file generation interface illustrated in FIG. 4.

Through the above embodiment, the free switch between file formats may be implemented, and users may select a format of the configuration file to be generated according to the actual technical requirements, so as to obtain a configuration file that meets the actual technical requirements.

Through the above step 103, it only implements the generation of the configuration file. Further, users may according to actual requirements choose the manner of obtaining the configuration file.

In some embodiments, a file downloading control, a code copying control and a code writing control may be provided in the configuration file generation interface, such that users may download the generated configuration file through the file downloading control; or copy the code in the generated configuration file through the code copying control; or write the code in the generated configuration file into the project code of the project to be configured through the code writing control.

In a possible implementation, if a user triggers the file downloading control, the electronic device may download the configuration file to local storage in response to the triggering operation on the file download control.

In some embodiments, the file downloading control may be provided as a first downloading control and a second downloading control. In the configuration file generation interface, each generated configuration file may correspond to a first downloading control, such that users may download the configuration file by triggering the first downloading control corresponding to a certain configuration file; while the second downloading control may also be referred to as the altogether downloading control, only one second downloading control is needed in a configuration file generation interface, and users may download the generated configuration files in different formats with one click by triggering the second downloading control.

Still taking the configuration file generation interface illustrated in FIG. 4 as an example, in the configuration file generation interface illustrated in FIG. 4, a download button 401 and a downloading button 402 are first downloading controls, and a download altogether button 403 is the second downloading control. Users may download an application.properties file by triggering the download button 401, download a quartz.properties file by triggering the download button 402, or, download the application.properties file and the quartz.properties file altogether at once by triggering the download altogether button 403.

In another possible implementation, if a user triggers the code copying control, the electronic device may copy code in the configuration file to a clipboard in response to a triggering operation on the code copying control, so as to implement copying of the code included in the configuration file.

In the configuration file generation interface, each generated configuration file may correspond to a code copying control, such that users may copy the code included in the configuration file by triggering the code copying control corresponding to a certain configuration file.

Still taking the configuration file generation interface illustrated in FIG. 4 as an example, in the configuration file generation interface illustrated in FIG. 4, a copy content button 404 and a copy content button 405 are code copying controls. Users may copy code in the application.properties file by triggering the copy content button 404, or, copy code in the quartz.properties file by triggering the copy content button 405.

In another possible implementation, if a user triggers the code writing control, the electronic device may write code in the configuration file into a target project file in response to a triggering operation on the code writing control, so as to achieve the purpose of writing the code in the configuration file into the project code of the project to be configured.

Still taking the configuration file generation interface illustrated in FIG. 4 as an example, in the configuration file generation interface illustrated in FIG. 4, a write into project button 406 is a code writing control. Users may write the code in the generated configuration file into the project code of the project to be configured by triggering the write into project button 406.

Through the above embodiment, a series of operations such as single configuration file downloading, free copying of configuration file, one-click downloading of all configuration files, and automatic writing of configuration items into the project, etc., may be implemented. Such designs may improve the flexibility of the configuration file generation process, improve the component configuration efficiency, and greatly improve user interaction experience.

For ease of understanding, referring to the interfaces illustrated in FIG. 2 to FIG. 4, the implementation process of the component configuration method provided in the present disclosure is described in detail below. According to the actual requirements, a user may select the target project component that need to be configured in the component selection interface illustrated in FIG. 2, and after the selection is completed, in response to the user's operation in the component selection interface, the computing device may obtain the target project component selected by the user in the component selection interface, and take the target project component as the input of the subsequent process, such that the component configuration interface illustrated in FIG. 3 may be displayed based on the target project component selected in the component selection interface, and the parameter values of the configuration parameters corresponding to each target project component may be configured in the component configuration interface, such that the user may set the parameter value of each configuration parameter in the component configuration interface, and after the parameter value is set, the user may trigger the confirmation operation in the component configuration interface. Then, in response to the user's confirmation operation in the component configuration interface, the computing device may obtain the parameter values set by the user in the component configuration interface, and then pass the obtained parameter values to the subsequent process as the data basis when generating codes. The computing device may display the configuration file generation interface illustrated in FIG. 4, such that the user may select the configuration file type for the user's requirements through the configuration file generation interface, and then the computing device may generate a configuration file according to the configuration file type selected by the user and the obtained parameter values.

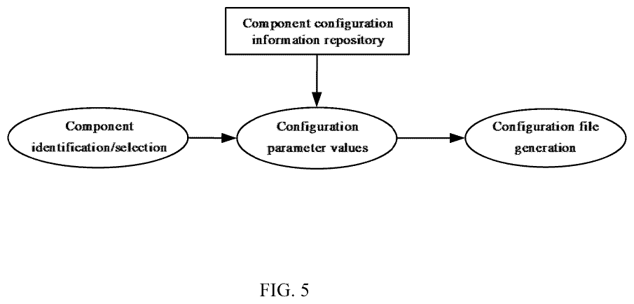

The schematic flow of the component configuration method provided by the present disclosure may be seen in FIG. 5. FIG. 5 is a flowchart of a component configuration method according to an embodiment of the present disclosure. As illustrated in FIG. 5, after the target project component is obtained through component identification/selection, the parameter values of configuration parameters of the target project component may be set based on the component configuration information repository, to implement generation of the configuration file.

In addition, it should be noted that the component configuration method provided by the present disclosure will involve the interaction between the front-end, back-end, and the cloud. To facilitate understanding, the data interaction process of the component configuration method provided by the present disclosure will be described below with an exemplary system architecture.

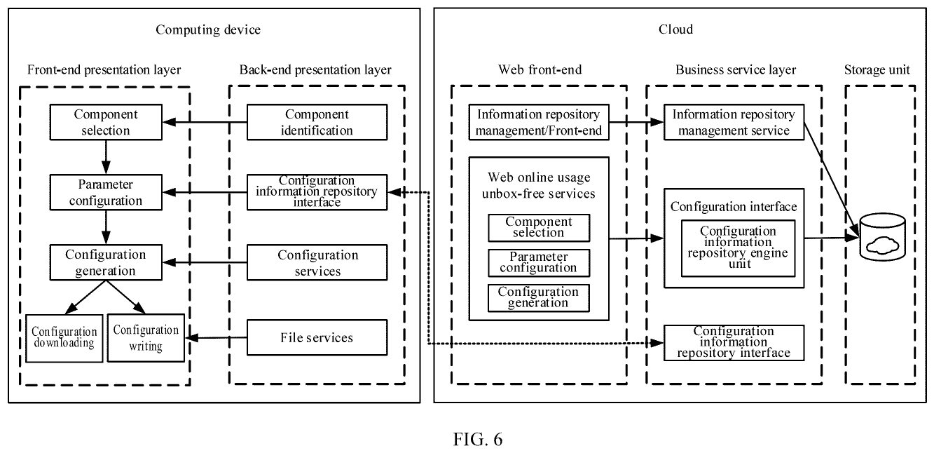

Referring to FIG. 6, which is a system architecture diagram of a component configuration system according to an embodiment of the present disclosure. As illustrated in FIG. 6, the computing device may provide component selection, parameter configuration, configuration generation (i.e., configuration file generation), and other functions through the front-end presentation layer, where the configuration generation function may include configuration downloading and configuration writing. Users may operate through the functions provided by the front-end presentation layer to implement data interaction between the front-end and the back-end. For example, component identification may be implemented by the back-end service layer to implement component selection, parameter configuration may be implemented by the back-end service layer through the information repository interface (i.e., the query interface), and configuration generation may be implemented through the configuration service provided by the back-end service layer, in addition, configuration downloading or configuration writing may be implemented through the file services provided by the back-end service layer.

The back-end service layer implements parameter configuration through the information repository interface (i.e., the query interface), which is the process of the back-end service layer querying the required configuration parameters from the component configuration information repository in the cloud through the information repository interface. Specifically, the cloud may be divided into Web front-end, business service layer and storage units, and the storage units are where the component configuration information repository is actually stored. To ensure that the computing device may implement the query of the component configuration information repository through the information repository interface belonging to the business service layer, the information repository management service and the information repository engine may be configured in the business service layer. The information repository management service is configured to provide a parameter query service for a computing device when there is a query requirement. The computing device may call the information repository management service through the information repository management front-end of the Web front-end, while the information repository engine is configured to execute the query process to obtain the required query parameters, and the computing device may call the information repository engine through a variety of unbox-free services provided by the Web front-end. Each component of the above component configuration system may work together to implement the component configuration method provided by the present disclosure.

Through the component configuration method provided by the present disclosure, it is possible to quickly search for the configuration items (i.e., configuration parameters) that need to be set for each project component, which saves developers the time cost of searching for configuration items; in addition, presetting the configuration parameters of project components of different component types and/or component versions may help users accurately locate the required configuration of each component. In addition, the component configuration method provided by the present disclosure may support many components under the common framework Spring Boot, and developers may use it through SDK integration or online usage to implement component parameter configuration, which is very convenient. The component configuration method provided in the present disclosure is compared with several component configuration methods (including the methods of querying official documents, source code decompilation with IDEA, using spring initializr, using JBolt, using network search) commonly used in related art as described below, to help understand the component configuration method provided in the present disclosure. The specific comparison results may be seen in Table 1 below.

TABLE 1

| | | Can | | | | | |
|---|---|---|---|---|---|---|---|
| | | configuration | | | Can | | |
| | | items be | Support | | configuration | | Configuration |
| | Time | accurately | multiple | Project | instructions | | generation |
| Scheme | cost | located? | components? | framework | be provided? | Implementation | manner |
| Querying | High | No | Not support | — | No | — | — |
| official | | | | | | | |
| documents | | | | | | | |
| Source code | Low | Yes | Support | Spring Boot | No | IDEA | Decompilation |
| decompilation | | | | | | plugin | |
| spring | Unable to configure parameters | | | | | | |
| initializr | | | | | | | |
| JBolt | Low | No | Only | JFinal | No | Eclipse | Automatically |
| | | | supports a | | | plugin | writing a |
| | | | small | | | | small quantity |
| | | | portion | | | | of |
| | | | | | | | configuration |
| | | | | | | | items |
| Network | High | No | Not support | — | No | — | — |
| search | | | | | | | |
| The present | Low | Yes | Support | Spring Boot | Yes | SDK | component |
| disclosure | | | | | | integration | selection, |
| | | | | | | or unbox- | component |
| | | | | | | free online | automatic |
| | | | | | | usage | scanning, |
| | | | | | | | component |
| | | | | | | | version |
| | | | | | | | screening, |
| | | | | | | | configuration |
| | | | | | | | intelligent |
| | | | | | | | library engine, |
| | | | | | | | configuration |
| | | | | | | | automatic |
| | | | | | | | writing, and |
| | | | | | | | supporting |
| | | | | | | | independent |
| | | | | | | | download |

Corresponding to the embodiments of the aforementioned method, the present disclosure further provides embodiments of a corresponding component configuration apparatus and an electronic device applied to it.

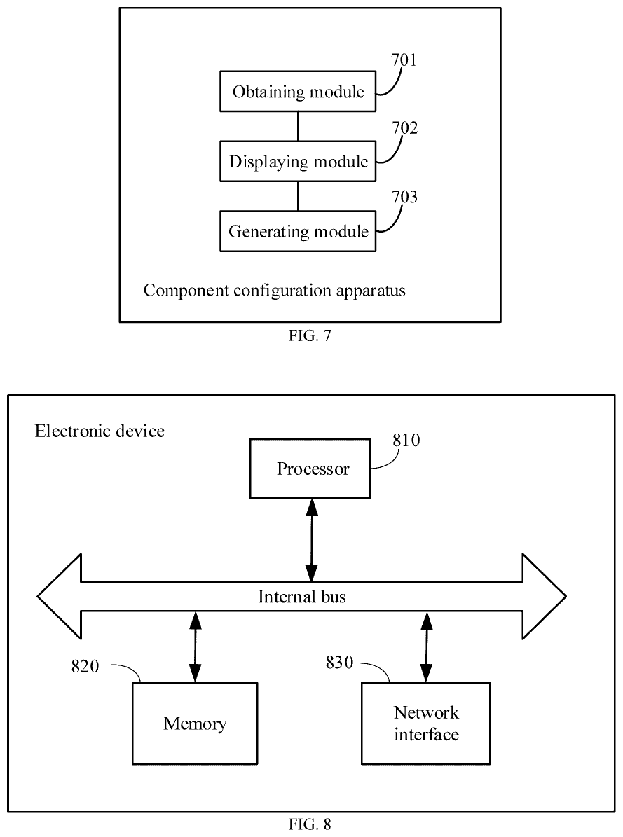

Referring to FIG. 7, FIG. 7 is a box diagram of a component configuration apparatus according to an embodiment of the present disclosure, as illustrated in FIG. 7, the apparatus includes:
an obtaining module 701, configured to obtain configuration parameters corresponding to a target project component to be configured based on preset component configuration information, where the preset component configuration information indicates configuration parameters corresponding to each project component;
a displaying module 702, configured to display a component configuration interface based on the target project component and the configuration parameters corresponding to the target project component, where the component configuration interface is configured to set parameter values of the configuration parameters corresponding to the target project component; and
a generating module 703, configured to generate a configuration file based on the target project component and the parameter values set through the component configuration interface.

In some embodiments of the present disclosure, in the preset component configuration information, configuration parameters corresponding to different types and/or different versions of project components are different.

The obtaining module 701, when configured to obtain configuration parameters corresponding to the target project component to be configured based on preset component configuration information, is configured to:
based on a component type and a component version of the target project component, obtain configuration parameters matching the component type and component version of the target project component from the preset component configuration information.

In some embodiments of the present disclosure, the obtaining module 701 is further configured to obtain the target project component to be configured.

In some embodiments of the present disclosure, the obtaining module 701, when configured to obtain the target project component to be configured, is further configured to perform any one of the following:
displaying a component selection interface, displaying at least one selectable project component in the component selection interface, and based on a component selection operation in the component selection interface, obtaining a selected selectable project component as the target project component; and
performing file and/or code scanning based on a project to be configured, to obtain the target project component.

In some embodiments of the present disclosure, the displaying module 702, when configured to display the component configuration interface based on the target project component and the configuration parameters corresponding to the target project component, is configured to:
display the component configuration interface, and display the target project component in the component configuration interface;
in response to a triggering operation on the target project component, display configuration parameters corresponding to a triggered target project component in the component configuration interface.

In some embodiments of the present disclosure, the component configuration interface is provided with an input control, and the input control is configured to obtain the parameter values of the configuration parameters corresponding to the target project component.

The obtaining module 701 is further configured to obtain parameter values input through the input control in the component configuration interface.

In some embodiments of the present disclosure, for any one project component, a configuration parameter corresponding to the project component is preset with a default parameter value.

The displaying module 702 is further configured to, in response to a triggering operation on the target project component, display configuration parameters corresponding to a triggered target project component in the component configuration interface, and display default parameter values for the displayed configuration parameters.

In some embodiments of the present disclosure, the obtaining module 701 is further configured to obtain, in response to a modification operation on the default parameter value in the input control, modified parameter values as parameter values of the configuration parameters.

In some embodiments of the present disclosure, the component configuration interface is further configured to display prompt information, the prompt information prompts one or more required configuration parameters among the configuration parameters, and/or, the prompt information prompts one or more forbidden parameter values of the configuration parameter.

In some embodiments of the present disclosure, the generating module 703, when configured to generate a configuration file based on the target project component and the parameter values set through the component configuration interface, is configured to:
in response to a confirmation operation in the component configuration interface, display a configuration file generation interface, where the configuration file generation interface includes at least one selectable file format;
in response to a file generation operation in the configuration file generation interface, generate a configuration file matching the selected selectable file format.

In some embodiments of the present disclosure, the configuration file generation interface further includes a file downloading control, a code copying control, and a code writing control;
the apparatus further includes:
a downloading module, configured to, in response to a triggering operation on the file downloading control, download the configuration file to local storage;
a copying module, configured to, in response to a triggering operation on the code copying control, copy code in the configuration file to a clipboard;
a writing module, configured to, in response to a triggering operation on the code writing control, write code in the configuration file into a target project file.

For the embodiments of the apparatus, since they basically correspond to the embodiments of the method, they may be referred to the partial description of the embodiments of the method. The apparatus embodiments described above are for illustrative purposes only, and the modules described as separate components may or may not be physically separated, and the components displayed as modules may or may not be physical modules, that is, may be located in one place, or can be distributed to multiple network modules. Some or all of these modules can be selected according to actual needs to achieve the purpose of the solution in the present disclosure. Those of ordinary skill in the art can understand and implement the present disclosure without any creative effort.

The present disclosure further provides an electronic device, referring to FIG. 8, which is a structural diagram of an electronic device according to an embodiment of the present disclosure. As illustrated in FIG. 8, the electronic device includes a processor 810, a memory 820, and a network interface 830. The memory 820 is configured to store computer instructions executable on the processor 810. The processor 810 is configured to implement the component configuration method provided by any embodiment of the present application when executing the computer instructions. The network interface 830 is configured to implement input and output functions. In more possible implementations, the electronic device may further include other hardware, which is not limited in the present disclosure.

The present disclosure further provides a computer-readable storage medium, which may be applied in different forms. For example, in different examples a computer-readable storage mediums may be a Radom Access Memory (RAM), a volatile memory, a non-volatile memory, a flash memory, a storage drive (e.g., a hard disk drive), a solid state hard disk, any type of storage disk (e.g., an optical disks, DVD, etc.), or a similar storage medium, or a combination thereof. In particular, the computer-readable medium may also be paper or other suitable media capable of printing the program. A computer program is stored on the computer-readable storage medium, and when the computer program is executed by the processor, the component configuration method provided by any embodiment of the present disclosure is implemented.

The present disclosure further provides a computer program product including a computer program. When the computer program is executed by a processor, the component configuration method provided by any embodiment of the present disclosure is implemented.

Those skilled in the art should understand that, one or more embodiments of the present specification may be provided as a method, an apparatus, an electronic device, a computer-readable storage medium, or a computer program product. Therefore, one or more embodiments of the present specification may take the form of a complete hardware embodiment, a complete software embodiment, or an embodiment combining software and hardware aspects. Moreover, one or more embodiments of the present specification can take the form of a computer program product implemented on one or more computer usable storage media (including but not limited to a magnetic disk storage, a CD-ROM, an optical storage, etc.) including computer usable program code.

Each embodiment in the present specification is described in a progressive manner, and the same or similar parts between the various embodiments may be referred to each other. Each embodiment focuses on the differences from other embodiments. Especially, an electronic device embodiment is basically similar to a method embodiment, and therefore is described briefly; for related parts, reference may be made to partial descriptions in the method embodiment.

Specific embodiments of the present specification have been described above. Other implementations are within the scope of the present disclosure. In some cases, the actions or steps recited in the claims may be performed in a different order than in the embodiments and the desired result may still be achieved. In addition, the processes depicted in the figures may not require the particular order shown or sequential order to achieve the desired results. In some embodiments, multitasking and parallel processing are also possible or may be advantageous.

Embodiments of the subject matter and functional operations described in the present specification can be implemented in one or a combination of: a digital electronic circuit, tangibly embodied computer software or firmware, computer hardware including the structures disclosed in the present specification and their structural equivalents. Embodiments of the subject matter described in the present specification may be implemented as one or more computer programs, that is, one or more modules of computer program instructions encoded on a tangible non-transitory program carrier to be executed by or control a data processing apparatus. Alternatively or additionally, program instructions can be encoded on an artificially generated propagation signal, such as a machine-generated electrical, optical, or electromagnetic signal, which is generated to encode and transmit the information to a suitable receiver apparatus and to be executed by the processing apparatus. The computer storage medium can be a machine-readable storage device, a machine-readable storage substrate, a random or serial access memory device, or a combination of one or more of them.

The processes and logic flows described in the present specification can be performed by one or more programmable computers that execute one or more computer programs to perform corresponding functions by operating according to input data and generating output. The processing and logic flow can also be performed by a dedicated logic circuit, such as a field programmable gate array (FPGA) or an application specific integrated circuit (ASIC), and the apparatus can also be implemented as a dedicated logic circuit.

Computers suitable for executing computer programs include, for example, general-purpose and/or special-purpose microprocessors, or any other type of central processing units. Generally, the central processing unit will receive instructions and data from a read-only memory and/or a random access memory. The basic components of a computer include a central processing unit for implementing or executing instructions and one or more memory devices for storing instructions and data. Generally, the computer will also include one or more mass storage devices for storing data, such as magnetic disks, magneto-optical disks, or optical disks, or the computer will be operably coupled to the mass storage device from/to which data is received or transmitted, or both. However, the computer does not have to have such a device. In addition, the computer can be embedded in another device, such as a mobile phone, a personal digital assistant (PDA), a mobile audio or a video player, a game console, a global positioning system (GPS) receiver, or, for example, a portable storage device of a universal serial bus (USB) flash drive, to name a few.

Computer-readable media suitable for storing computer program instructions and data include all forms of non-volatile memories, media, and memory devices, including, for example, semiconductor memory devices (such as EPROMS, EEPROMs, and flash memory devices), magnetic disks (such as internal hard disks or removable disks), magneto-optical disks and CD ROMs and DVD-ROM disks. The processor and the memory can be supplemented by, or incorporated in, dedicated logic circuits.

Although the present specification contains many specific implementation details, these should not be construed as limiting the scope of any disclosure or the scope of protection as claimed, but are mainly used to describe features of specific embodiments of a particular disclosure. Certain features described in multiple embodiments within the present specification can also be implemented in combination in a single embodiment. On the other hand, various features described in a single embodiment can also be implemented separately in multiple embodiments or in any suitable sub-combination. Furthermore, although features can function in certain combinations as described above and even initially claimed as such, in some cases one or more features from the claimed combination can be removed from the combination and required protected combinations can point to sub-combinations or variations of sub-combinations.

Similarly, although the operations are depicted in a specific order in the drawings, this should not be construed as requiring these operations to be performed in the specific order shown or sequentially, or requiring all illustrated operations to be performed to achieve the desired result. In some cases, multitasking and parallel processing may be advantageous. In addition, the separation of various system modules and components in the above embodiments should not be understood as requiring such separation in all embodiments, and it should be understood that the described program components and systems can generally be integrated together in a single software product medium, or packaged into multiple software products.

Thus, specific embodiments of the subject matter have been described. Other implementations are within the scope of the present disclosure. In some cases, the actions or steps recited in the claims may be performed in a different order than in the embodiments, and the desired result may still be achieved. In addition, the processes depicted in the figures do not require the particular order shown, or sequential order, to achieve desirable results. In some cases, multitasking and parallel processing may be advantageous.

Those skilled in the art can think of other implementations of the present specification after considering the specification and practice of the present disclosure herein. The present disclosure is intended to cover any variations, uses, modification or adaptations of the present disclosure that follow the general principles of the present specification and include common knowledge or conventional technical methods in the related art that are not disclosed in the present disclosure. That is, the present disclosure is not limited to the precise structure described above and shown in the accompanying drawings, and various modifications and changes can be made without departing from the scope of the present specification.

The above are the selectable embodiments of the present disclosure, which are not intended to limit the disclosure. Any modification, equivalent substitution, or improvement made within the spirit and principle of the present disclosure shall be included within the protection scope of the disclosure.

1. A component configuration method, comprising:
obtaining, based on preset component configuration information, configuration parameters corresponding to a target project component, wherein the preset component configuration information indicates configuration parameters corresponding to each project component;
displaying, based on the target project component and the configuration parameters corresponding to the target project component, a component configuration interface, wherein the component configuration interface is configured to set parameter values of the configuration parameters corresponding to the target project component; and
generating, based on the target project component and the parameter values set through the component configuration interface, a configuration file.

2. The method according to claim 1, wherein in the preset component configuration information, configuration parameters corresponding to different types of project components are different, and/or, configuration parameters corresponding to different versions of project components are different;
wherein obtaining, based on preset component configuration information, the configuration parameters corresponding to the target project component comprises:
obtaining, based on a component type and a component version of the target project component, configuration parameters matching the component type and the component version of the target project component from the preset component configuration information.

3. The method according to claim 1, wherein before obtaining, based on preset component configuration information, the configuration parameters corresponding to the target project component, the method further comprises:
obtaining the target project component.

4. The method according to claim 3, wherein obtaining the target project component comprises:
displaying a component selection interface, displaying at least one selectable project component in the component selection interface, and obtaining, based on a component selection operation in the component selection interface, a selected selectable project component as the target project component;
performing file and/or code scanning based on a project, to obtain the target project component; or
both.

5. The method according to claim 1, wherein displaying, based on the target project component and the configuration parameters corresponding to the target project component, the component configuration interface comprises:
displaying the component configuration interface, and displaying the target project component in the component configuration interface; and
displaying, in response to a triggering operation on the target project component, the configuration parameters corresponding to the target project component in the component configuration interface.

6. The method according to claim 5, wherein the component configuration interface is provided with an input control configured to obtain the parameter values of the configuration parameters corresponding to the target project component;
before generating, based on the target project component and the parameter values set through the component configuration interface, the configuration file, wherein the method further comprises:
obtaining parameter values input through the input control in the component configuration interface.

7. The method according to claim 6, wherein for any one project component, a configuration parameter corresponding to the project component is preset with a default parameter value;
the method further comprises:
displaying, in response to a triggering operation on the target project component, the configuration parameters corresponding to the target project component in the component configuration interface, and displaying default parameter values for the configuration parameters.

8. The method according to claim 7, wherein after displaying, in response to a triggering operation on the target project component, the configuration parameters corresponding to the target project component in the component configuration interface, and displaying the default parameter values for the displayed configuration parameters, the method further comprises:
obtaining, in response to a modification operation on the default parameter values in the input control, modified parameter values as the parameter values of the configuration parameters.

9. The method according to claim 1, wherein the component configuration interface is further configured to display prompt information, wherein the prompt information prompts one or more required configuration parameters among the configuration parameters, and/or, one or more forbidden parameter values of the configuration parameters.

10. The method according to claim 1, wherein generating, based on the target project components and the parameter values set through the component configuration interface, the configuration file comprises:
displaying, in response to a confirmation operation in the component configuration interface, a configuration file generation interface, wherein the configuration file generation interface comprises at least one selectable file format; and
generating, in response to a file generation operation in the configuration file generation interface, a configuration file matching a selected selectable file format.

11. The method according to claim 10, wherein the configuration file generation interface further comprises a file downloading control, a code copying control, and a code writing control;
after generating, in response to the file generation operation in the configuration file generation interface, the configuration file matching the selected selectable file format, the method further comprises any one of:
downloading, in response to a triggering operation on the file downloading control, the configuration file to a local storage;
copying, in response to a triggering operation on the code copying control, code in the configuration file to a clipboard;
writing, in response to a triggering operation on the code writing control, code in the configuration file into a target project file; or
any combinations thereof.

12. (canceled)

13. An electronic device, comprising a memory, a processor, and a computer program stored in the memory and executable on the processor, wherein the processor executes the computer program to implement a method comprising:
obtaining, based on preset component configuration information, configuration parameters corresponding to a target project component, wherein the preset component configuration information indicates configuration parameters corresponding to each project component;
displaying, based on the target project component and the configuration parameters corresponding to the target project component, a component configuration interface, wherein the component configuration interface is configured to set parameter values of the configuration parameters corresponding to the target project component; and
generating, based on the target project component and the parameter values set through the component configuration interface, a configuration file.

14. A non-volatile computer-readable storage medium storing a program, the program when executed by a processor implementing a method comprising:
obtaining, based on preset component configuration information, configuration parameters corresponding to a target project component, wherein the preset component configuration information indicates configuration parameters corresponding to each project component;
displaying, based on the target project component and the configuration parameters corresponding to the target project component, a component configuration interface, wherein the component configuration interface is configured to set parameter values of the configuration parameters corresponding to the target project component; and
generating, based on the target project component and the parameter values set through the component configuration interface, a configuration file.

15. The non-volatile computer-readable storage medium according to claim 14, wherein in the preset component configuration information, configuration parameters corresponding to different types of project components are different, and/or, configuration parameters corresponding to different versions of project components are different;
wherein obtaining, based on preset component configuration information, the configuration parameters corresponding to the target project component comprises:
obtaining, based on a component type and a component version of the target project component, configuration parameters matching the component type and the component version of the target project component from the preset component configuration information.

16. The non-volatile computer-readable storage medium according to claim 14, wherein before obtaining, based on preset component configuration information, the configuration parameters corresponding to the target project component, the processor is further configured to implement operations comprising:
obtaining the target project component.

17. The non-volatile computer-readable storage medium according to claim 16, wherein obtaining the target project component comprises:
displaying a component selection interface, displaying at least one selectable project component in the component selection interface, and obtaining, based on a component selection operation in the component selection interface, a selected selectable project component as the target project component;
performing file and/or code scanning based on a project, to obtain the target project component; or
both.

18. The non-volatile computer-readable storage medium according to claim 14,
wherein displaying, based on the target project component and the configuration parameters corresponding to the target project component, the component configuration interface comprises:
displaying the component configuration interface, and displaying the target project component in the component configuration interface; and
displaying, in response to a triggering operation on the target project component, the configuration parameters corresponding to the target project component in the component configuration interface.

19. The non-volatile computer-readable storage medium according to claim 18, wherein the component configuration interface is provided with an input control configured to obtain the parameter values of the configuration parameters corresponding to the target project component;
before generating, based on the target project component and the parameter values set through the component configuration interface, the configuration file, wherein the processor is further configured to implement operations comprising:
obtaining parameter values input through the input control in the component configuration interface.

20. The non-volatile computer-readable storage medium according to claim 19, wherein for any one project component, a configuration parameter corresponding to the project component is preset with a default parameter value;
the processor is further configured to implement operations comprising:
displaying, in response to a triggering operation on the target project component, the configuration parameters corresponding to the target project component in the component configuration interface, and displaying default parameter values for the configuration parameters.

21. The non-volatile computer-readable storage medium according to claim 20, wherein after displaying, in response to a triggering operation on the target project component, the configuration parameters corresponding to the target project component in the component configuration interface, and displaying the default parameter values for the displayed configuration parameters the processor is further configured to implement operations comprising:
obtaining, in response to a modification operation on the default parameter values in the input control, modified parameter values as the parameter values of the configuration parameters.
